(19) United States
(12) Patent Application Publication
(10) Pub. No.: US 2009/0100184 A1
(43) Pub. Date: Apr. 16, 2009

(54) PROTECTING CONTEXT SENSITIVE INFORMATION FROM BEING TRANSMITTED FROM AN INSTANT MESSAGE CLIENT

(75) Inventors: Al Chakra, Apex, NC (US); Frank L. Jania, Chapel Hill, NC (US); David M. Ogle, Cary, NC (US); Hema Srikanth, Cary, NC (US)

Correspondence Address: STRATEGIC PATENT GROUP, P.C., P.O. BOX 1329, MOUNTAIN VIEW, CA, 94042, US

(73) Assignee: INTERNATIONAL BUSINESS MACHINES CORPORATION, Armonk, NY (US)

(21) Appl. No.: 11/873,006

(22) Filed: Oct. 16, 2007

(51) Int. Cl. G06F 15/16

(52) U.S. Cl. 709/229

(57) ABSTRACT

In a method and system for protecting context sensitive information from being transmitted from an instant message client, at least one policy is received that includes an entry of one or more disallowed terms and is associated with at least one action. Words typed into an IM message of the IM client by a user are then monitored in real-time. In response to any of the words typed into the IM message matching any of one or more disallowed terms, the action associated with the policy is automatically performed. According to one embodiment, an example action that may be associated with the policy and that is automatically performed may include temporarily halting transmission of the IM message, and displaying a warning message to the user, for example.

### BACKGROUND OF THE INVENTION

Instant messaging (IM) applications have become the most prevalent means of communication in recent years. This use of IM has been increasingly pervasive across several disciplines, where information passed among users can be very sensitive and any disclosure of unintended information could be damaging. For example, consider a situation where a user has several applications launched on the desktop, such as email, intranet, and Internet account applications. Each application window may be password protected and require the user to submit a valid password when the application starts. The focus of the application windows on the desktop can change easily by the user mistakenly clicking on the wrong window.

If an IM application is also running, and the user receives a new IM message, the focus of the windows will also change from the intended application window to the new IM window that pops-up. Typing-in sensitive information, e.g., a password, into one application window, while an IM window unexpectedly pops up may result in the user inadvertently exposing or giving away the sensitive information via this new IM thread. If the user compromises sensitive information, such as a password, in this manner, then the user has to change the password in all the applications for which the user uses the same password, or the user faces a security risk.

In addition, the transmission of sensitive information via instant messaging may not always happen by mistake. Sometimes it could be because of a lack of knowledge on the user's part that some information is deemed confidential. For example, product code names, customer lists, and other types of business sensitive information can be inadvertently transmitted across instant messaging application. As entities such as corporations and governments connect internal IM systems to external public and private IM systems, there is an increased need to protect context sensitive information from being unintentionally, or intentionally, disclosed.

### BRIEF SUMMARY OF THE INVENTION

In a method and system for protecting context sensitive information from being transmitted from an instant message client, at least one policy is received that includes an entry of one or more disallowed terms and is associated with at least one action. Words typed into an IM message of the IM client by a user are then monitored in real-time. In response to any of the words typed into the IM message matching any of one or more disallowed terms, the action associated with the policy is automatically performed. According to one embodiment, an example action that may be associated with the policy and that is automatically performed may include temporarily halting transmission of the IM message, and displaying a warning message to the user, for example.

### BRIEF DESCRIPTION OF THE DRAWINGS

FIG. 1 is a logical block diagram illustrating an exemplary network system environment in which one embodiment of the present invention for protecting context sensitive information may be implemented.

FIG. 2 is a diagram illustrating a process for protecting context sensitive information from being transmitted from the instant message client according to an exemplary embodiment.

FIG. 3 is a diagram illustrating a warning message displayed by the IM monitoring application in response to detection of a disallowed word entered in an IM message.

### DETAILED DESCRIPTION OF THE INVENTION

The present invention relates to a system of method for protecting context sensitive information from being transmitted from an instant message client. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The exemplary embodiment of the present invention provides a system and method that prevent a user from accidentally or intentionally without a warning giving away context sensitive information, such as passwords or confidential business related information, by allowing policy creation and maintenance with an instant messaging client. These policies allow the user to define disallowed terms and one or more rules that allow different actions to be taken upon look-up based on what terms are communicated and between whom in the IM message.

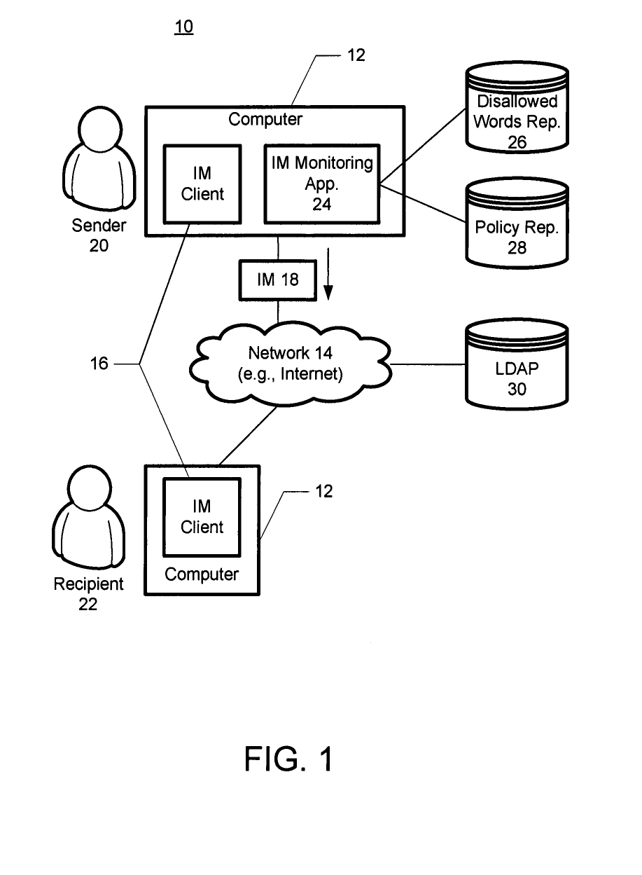

FIG. 1 is a logical block diagram illustrating an exemplary network system environment in which one embodiment of the present invention for protecting context sensitive information may be implemented. A network system environment 10 is shown in which two or more computers 12 communicate over a network 14. The network 14 may be a public network, such as the Internet, or a private network, such as an intranet, LAN, or WLAN, or a combination of the above. At least a portion of the computers 12 may execute corresponding messaging clients, such as instant messaging (IM) clients 16. As is well-known, IM clients 16 allow real-time communication between two or more users through the transmissions of text-based messages between the IM clients 16 of networked computers 12. Each IM message 18 is transmitted from a sender 20 to one or more addressed recipients 22. Although IM messages 18 are typically text-based, IM messages 18 may also include voice, digital images, and video.

According to the exemplary embodiment, an IM monitoring application 24 is provided that monitors in real-time words typed into the IM messaged 18 of the sender's IM client 16, and protects context-sensitive information for being transmitted to the recipient 22. In one embodiment, the IM monitoring application 24 may reside on the same computer as the IM client 16 that it monitors.

The IM monitoring application 24 may include a disallowed terms repository 26, a policy repository 28, and in some embodiments may access an entities' Lightweight Directory Access Protocol (LDAP) 30, e.g., an employee database. The IM monitoring application 24 allows the user to create and maintain policies regarding disallowed terms. These policies allow the user to define disallowed terms and one or more rules that allow different actions to be taken upon table look-up based on what terms are communicated and between whom in the IM message. The IM monitoring application 24 may be implemented in several ways. For example, the IM monitoring application 24 may be implemented as any of the following: as part of a customized IM client 16; as a plug-in to the IM client 16; as an application programming interface (API); or as a stand-alone application.

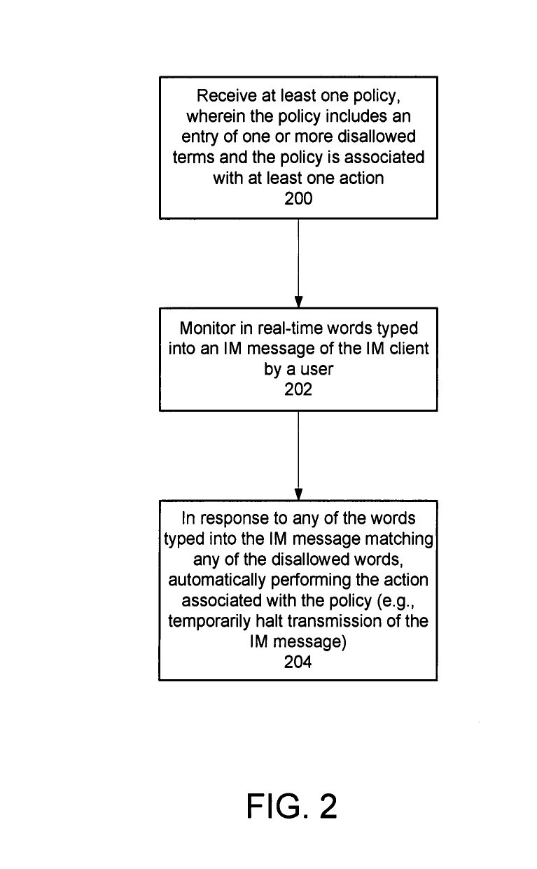

FIG. 2 is a diagram illustrating a process for protecting context sensitive information from being transmitted from the instant message client according to an exemplary embodiment. The process begins in step 200 by the IM monitoring application 24 receiving at least one policy, wherein the policy includes an entry of one or more disallowed terms, and the policy is associated with at least one action. In one embodiment, the IM monitoring application 24 may receive the policy from the user of the IM client 16, or from a third party, such an enterprise system administrator. In another embodiment, the policy may be provided as part of the IM client 16 or the IM monitoring application 24 as a default set of policies.

According to the exemplary embodiment, the disallowed terms are user-defined and are intended to cover words that are context sensitive to the user due to the context in which the words are used and that the user would not want to share with others. Thus, disallowed terms representing context-sensitive information may include a password, an item of personal business information (e.g., account numbers, Social Security numbers), an item of employer company confidential information, (e.g. product, code and customer names), and even mature words, for instance. As used herein, a disallowed term is not limited to a single word, but may also include a phrase or expression.

In one embodiment, policy creation may be performed through the IM client 16 (or alternatively through the IM monitoring application 24) by the user accessing a preference screen and selecting a “Policy Creation” option/tab. In response, a dialog may be opened that allows the user to “Create” or “Update” disallowed terms. If the user chooses to “Create” a disallowed term, a dialog box may open that allows the user to select a group of properties to associate with the term, such as private, public, open and the like. In addition, if access to the LDAP 30 is supported, a list of the user's employer hierarchy is displayed from which the user may select which manager, peers, and employees are given permission for the entered term to be sent to. The user may also be given an option to select what action is performed in the event that the term is ever typed into an IM message. For example, the user may enter a customizable warning message to display. This process is repeated for each entered term, where the properties from the previous entry may be automatically inherited by the next entered term.

In the exemplary embodiment, the IM monitoring application 24 stores the user-entered disallowed terms in a repository, such as the disallowed terms repository 26. In one embodiment, the disallowed terms repository 26 may be implemented as a database, while, in another embodiment, the disallowed terms repository 26 may be implemented as a flat file or table. The disallowed terms repository 26 may be stored on the same or different computer 12 than the IM monitoring application 24 and be accessed over the network 14. The IM monitoring application 24 may either continually access the disallowed terms repository 26 during execution, or import the words in the disallowed terms repository 26 during initiation. In a further embodiment, words may be stored in the disallowed terms repository 26 using hashing and/or encryption algorithms for security purposes.

In step 202, the IM monitoring application 24 monitors in real-time words typed into an IM message 18 of the IM client 16 by a user. In step 204, in response to any of the words typed into the IM message matching any of the disallowed words, the IM monitoring application 24 automatically performs the action associated with the policy. According to one embodiment, an example action that may be associated with the policy and automatically performed may include temporarily halting transmission of the IM message 18 and displaying a warning message. The warning message may be configure to be displayed to the user and/or to a third party, such a system administrator or security personnel. If the warning message is displayed to the user, the user may be provided with a choice to override the non-transmission of an IM message.

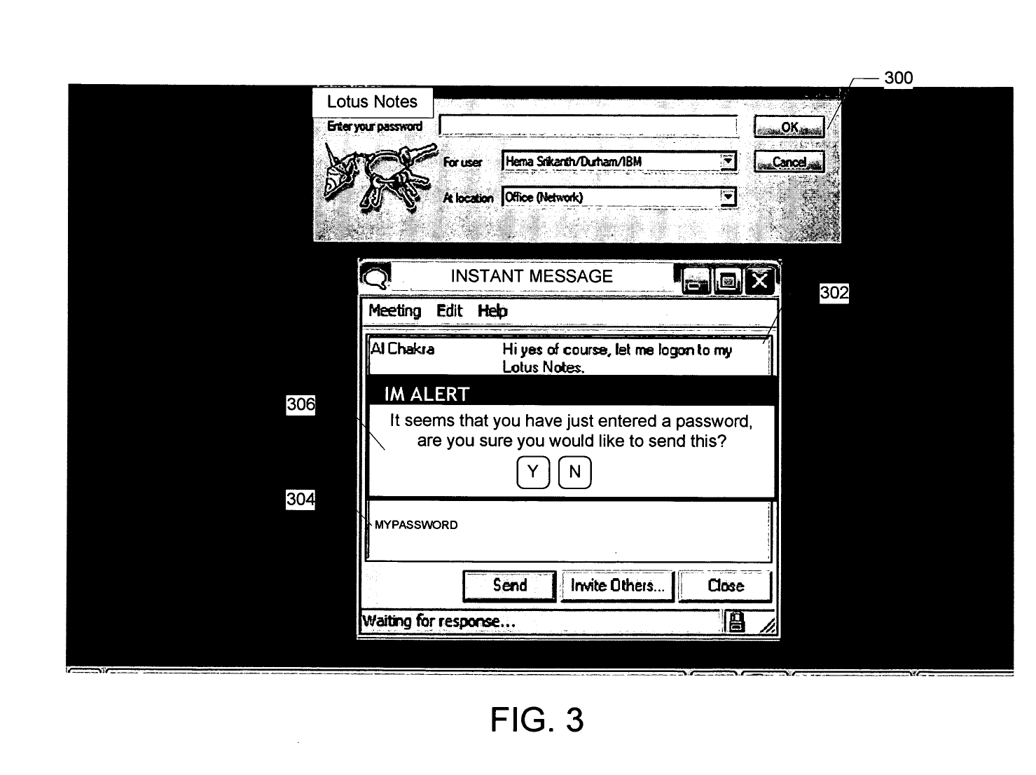

FIG. 3 is a diagram illustrating a warning message displayed by the IM monitoring application in response to detection of a disallowed word entered in an IM message. In this example, a user has started a LOTUS NOTES application and a LOTUS NOTES application window 300 has prompted the user to enter a password. As the user proceeds to type-in a password, an IM thread is initiated by the user's team member, causing an IM window 302 to pop-up. The user, not noticing the new IM window 302, proceeds to type in a password 304 into the IM message. Upon detection of this disallowed word, the IM monitoring application 24 halts transmission of the IM message and displays a warning message window 306 prompting the user to select whether they wish to proceed with sending the message with the password or not. Thus, the IM monitoring application 24 provides the user with a choice of overriding the halt of the message transmission by sending the message as is, or to edit the message before attempting to resend the message. In one embodiment, this override feature can be an option that is set within the preferences of the IM client 16. For example, if the user defined the password “idiot” as a disallowed word, then the user should be allowed to set a preference that overrides the non-transmission of an IM message containing this word via the IM client 16, such that the user can send the word “idiot” across an IM thread unimpeded.

According to one embodiment, the IM monitoring application 24 allows the user to define policies that include disallowed terms as well as one or more rules that may define different actions to be taken based on what disallowed terms are being communicated and between whom in the IM message. In one embodiment, the policies are stored in the policy repository 28. The policy repository 28 may reside on the same or different computer that the IM monitoring application 24.

The rules of the policies may be provided as IF, THEN statements, where the IF defines a first set of conditions of the match, such as the presence of a disallowed word; and a second set of conditions for the users, i.e., the sender and recipient(s). Conditions for the match for the disallowed words may be a simple query to the disallowed terms repository 26 using a word typed into an IM message, and/or involve one or more queries of a third-party database, e.g. a company product database or the LDAP 30. Conditions for the sender and recipient(s) may be the specification of actual user ID's of the sender 20 and recipient(s) 22, the roles of the sender 20 and recipient(s) 22, and/or the relationship between the roles of the sender 20 and recipient(s) 22. The determination of roles of the sender 20 and recipient(s) 22, and/or the relationship between the roles of the sender 20 and recipient(s) 22 may be determined by a query of the LDAP 30. The following example rules are provided to elucidate the above principles.

One example policy could be:
IF (Entered_Term matches *company password policy*; AND the Sender and Recipient(s) do not have manager-employee relationship);
THEN
   Display Alert message “This seems like password, would you like to send this?”
      In this example, the “company password Policy” could be defined as “A word that is less than or equal to 8 letters and does not match dictionary”, which would require integration with a dictionary.

Similarly, policies can be created to check if an entered word in an IM message 18 matches a code name for a company's products, e.g. IBM. An example policy could be:
IF (Entered_Term matches an IBM product code name; AND the Sender and Recipient(s) do not have manager-employee relationship OR not part of the same social network);
THEN
   ALERT Sender.
      An extended policy to the above example could be:
IF (Entered_Term matches a code name for an IBM product; AND Recipient(s) is external to IBM corp.);
THEN
   ALERT Sender and/or TRACK COMMUNICATION

In another example, a policy could be created that would disallow a user from sending mature words. A policy can be generated to especially prevent submission of mature words to any superiors in a management chain. For example, the policy could be:
IF (Entered_Term matches a mature word; AND Recipient(s) is in management chain)
THEN
   ALERT Sender

As a further example of what actions can be defined in a policy and carried out when keywords are entered into an IM session, consider an example company policy where terms, such as “confidential”, have been defined as a disallowed words and the policy flags any messages sent with those words that are sent to from a sender of that company to a recipient of any other company. One action that may be defined is to have the IM session logged and automatically sent to company security, with or without notification to the sender. In this embodiment, the creator of the policy is a user, such a company administrator or other third-party, rather than the user of the IM client 16.

During real-time monitoring of the IM client 16 (step 202), the IM monitoring application 24 first determines the user ID of the user and the recipient(s) 22. Typically, the user typing-in the words into the IM client 16 is the sender 20 of the IM message 18, and the recipient user ID can be found in the recipient field of the IM message 18. If LDAP 30 support is enabled, then the IM monitoring application 24 may also attempt to determine the relationship between the Sender 20 and Recipient(s) 22 by cross-referencing the LDAP 30 with the user IDs of the Sender 20 and Recipient(s) 22 and examining the corresponding employee's roles in the company. Next, the IM monitoring application 24 activates only those policies that satisfy the employee relationship when looking for matches of the disallowed terms.

A system of method for protecting context sensitive information from being transmitted from an instant message client has been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for protecting context sensitive information from being transmitted from an instant message (IM) client, the method comprising:
receiving at least one policy, wherein the at least one policy includes an entry of one or more disallowed terms, and is associated with at least one action;
monitoring in real-time words typed into an IM message of the IM client by a user; and
in response to any of the words typed into the IM message matching any of the one or more disallowed terms, automatically performing the at least one action associated with the at least one policy.

2. The method of claim 1 wherein performing the at least one action comprises temporarily halting transmission of the IM message and displaying a warning message.

3. The method of claim 2 further comprising providing the user with a choice of overriding the temporarily halting transmission of the IM message by sending the IM message as is, or to edit the IM message before attempting to resend the IM message.

4. The method of claim 1 further comprising receiving the at least one policy from at least one of: the user of the IM client, a third party system administrator, and as a default set of policies provided as part of the IM client.

5. The method of claim 1 wherein the at least one policy further comprises one or more rules that define different actions to be taken based on which ones of the one or more disallowed terms are being communicated and between whom in the IM message.

6. The method of claim 5 wherein the one or more rules define a first set of conditions of the match for the one or more disallowed terms, and a second set of conditions for a sender and a recipient(s).

7. The method of claim 6 wherein the first set of conditions includes a query of a third-party database, and the second set of conditions includes roles of the sender and the recipient(s).

8. The method of claim 7 wherein the second set of conditions includes relationships between the roles of the sender and the recipient(s).

9. The method of claim 1 wherein the one or more disallowed terms comprise at least one of a password, an item of personal business information, an item of employer company confidential information.

10. The method of claim 1 further comprising storing the one or more disallowed terms in a repository.

11. An executable software product stored on a computer-readable medium containing program instructions for protecting context sensitive information from being transmitted from an instant message (IM) client, the program instructions for:
receiving at least one policy, wherein the at least one policy includes an entry of one or more disallowed terms, and is associated with at least one action;
monitoring in real-time words typed into an IM message of the IM client by a user; and
in response to any of the words typed into the IM message matching any of the one or more disallowed terms, automatically performing the at least one action associated with the at least one policy.

12. The executable software product of claim 11 wherein performing the at least one action comprises temporarily halting transmission of the IM message and displaying a warning message.

13. The executable software product of claim 12 wherein in response to halting transmission of the IM message, providing the user with a choice of overriding the temporarily halting transmission of the IM message by sending the IM message as is, or to edit the IM message before attempting to resend the IM message.

14. The executable software product of claim 11 further comprising the receiving the at least one policy from at least one of: the user of the IM client, a third party system administrator, and as a default set of policies provided as part of the IM client.

15. The executable software product of claim 11 wherein the at least one policy further comprises one or more rules that define different actions to be taken based on which ones of the one or more disallowed terms are being communicated and between whom in the IM message.

16. The executable software product of claim 15 wherein the one or more rules define a first set of conditions of the match for the one or more disallowed terms, and a second set of conditions for a sender and a recipient(s).

17. The executable software product of claim 16 wherein the first set of conditions includes a query of a third-party database, and the second set of conditions includes roles of the sender and the recipient(s).

18. The executable software product of claim 17 wherein the second set of conditions includes a relationship between the roles of the sender and the recipient(s).

19. The executable software product of claim 11 wherein the one or more disallowed terms comprise at least one of a password, an item of personal business information, an item of employer company confidential information.

20. The executable software product of claim 11 further comprising storing the one or more disallowed terms in a repository.
